(19) United States
(12) Patent Application Publication
(10) Pub. No.: US 2014/0280084 A1
(43) Pub. Date: Sep. 18, 2014

(54) USING STRUCTURED DATA FOR SEARCH RESULT DEDUPLICATION

(71) Applicant: GOOGLE INC., (US)

(72) Inventor: Daniel W. Dulitz, Los Altos, CA (US)

(21) Appl. No.: 13/832,066

(22) Filed: Mar. 15, 2013

(51) Int. Cl. G06F 17/30

(52) U.S. Cl. CPC G06F 17/3053
USPC 707/723; 707/741

(57) ABSTRACT

Methods, systems, and apparatus, including computer programs encoded on computer storage media, for providing deduplicated search results. One of the methods includes receiving a plurality of search results obtained in response to a query, wherein the plurality of search results identify respective resources that include markup language structured data items, wherein each resource is associated with an entity set of entity identifiers corresponding to respective structured data items of the resource. If a particular entity set of the plurality of entity sets is duplicative, a ranking score of a particular search result that identifies a resource associated the particular entity set that is duplicative is modified.

### BACKGROUND

This specification relates to Internet search engines, and more particularly to ranking search results that are identified as being responsive to search queries.

Internet search engines aim to identify resources, e.g., web pages, images, text documents, multimedia content, e.g., videos, that are relevant to a user's information needs and to present information about the resources in a manner that is most useful to the user. Internet search engines generally return a set of search results, each identifying a respective resource, in response to a user submitted query.

### SUMMARY

This specification describes techniques for a system to reduce a number of search results that refer to the same entities. The system can parse structured data items embedded in web pages and map the structured data items to entities. The system can then adjust the resources indexed, search results provided, or both to reduce seemingly duplicative search results.

In general, one innovative aspect of the subject matter described in this specification can be embodied in methods that include the actions of receiving a plurality of search results obtained in response to a query, wherein the plurality of search results identify respective resources that include markup language structured data items, wherein each resource is associated with an entity set of entity identifiers corresponding to respective structured data items of the resource; determining that a particular entity set of the plurality of entity sets is duplicative; and in response to determining that a particular entity set of the plurality of entity sets is duplicative, modifying a ranking score of a particular search result that identifies a resource associated the particular entity set that is duplicative or identifying the particular search result as duplicative such that the particular search result is processed differently than if it had not been so identified. For example, the particular search result identified as duplicative can be pruned from a result set or can be displayed in proximity with another result associated with an entity set that gives rise to the duplicative assignment. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Modifying a rank of the particular search result comprises applying a demotion to a score of the particular search result or removing the particular search result from the obtained search results. The actions include determining that the particular entity set of the plurality of entity sets is duplicative of one or more entity sets of resources located on a same web site. The actions include determining each entity identifier including mapping a property value of a corresponding structured data item used as an entity alias to the entity identifier. The actions include receiving a resource; determining that the resource includes a particular structured data item that represents a particular entity; and in an index of resources, annotating the resource with an entity set of one or more entity identifiers that includes an identifier of the particular entity. Determining that the resource includes a particular structured data item that represents a particular entity comprises obtaining a property of the structured data item; determining that the property corresponds to an alias of a particular entity. Determining that the resource includes a particular structured data item that represents a particular entity comprises obtaining a second property of the structured data item; and determining that the second property corresponds to an alias of a second particular entity that has a relationship with the particular entity.

In general, another innovative aspect of the subject matter described in this specification can be embodied in methods that include the actions of receiving, by an indexing engine, data identifying each resource of the plurality of resources, wherein each resource includes one or more markup language structured data items; determining, for the plurality of resources, respective entity sets of one or more entity identifiers, each entity set corresponding to structured data items of a resource, including using a property value of each structured data item as an entity alias; determining that a particular entity set of the plurality of entity sets is duplicative; and in response to determining that the particular entity set is duplicative, indexing a particular resource having the duplicative entity set with an indication that the particular entity set is duplicative. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. The actions include in the index of resources, annotating the one or more resources with their respective entity sets. The actions include determining that the particular entity set of the plurality of entity sets is duplicative of one or more entity sets of resources located on a same web site. Determining a first entity set of one or more entity identifiers that each correspond to a respective structured data item of the one or more first structured data items comprises obtaining a property of a structured data item; and determining that the property corresponds to an alias of a particular entity. Determining that the resource includes a particular structured data item that represents a particular entity comprises obtaining a second property of the structured data item; and determining that the second property corresponds to an alias of a second particular entity that has a relationship with the particular entity.

Particular embodiments of the subject matter described in this specification can be implemented so as to realize one or more of the following advantages. A search system can map structured data items to entities to determine what entities, if any, are referenced by a web page. Reducing duplicative search results from a same site can provide a user with a greater diversity of search results that identify a larger number of sites.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example web page.

FIG. 2 illustrates an example search results page.

FIG. 3 is a diagram of an example system.

FIG. 4 is a flow chart of an example process for determining that structured data items correspond to entities.

FIG. 5 is a flow chart of an example process for disambiguating two candidate entities for a structured data item.

FIG. 6 is a flow chart of an example process for indexing resources associated with entities.

FIG. 7 is a flow chart of an example process for obtaining search results that reference resources having structured data.

Like reference numbers and designations in the various drawings indicate like elements.

### DETAILED DESCRIPTION

This specification describes how a search system can map structured data items in resources, e.g., markup language tagged content on web pages, to entities in order to determine what entities are referred to by the resource. This allows the search system to alter the indexing and/or scoring of resources in various ways to eliminate overly duplicative search results provided by the search system.

In general, the term “entity” refers to something that exists by itself, which can be a person, place, thing, or idea, for example. A search system can maintain an entity database that stores information about various entities and various relationships between entities. For example, the system can store various data about the real-world entity the Statue of Liberty, for example, the text string “the Statue of Liberty,” a location, a description, resources about the entity, images, in addition to a variety of other types of information.

The system can assign a unique entity identifier to each entity. The system can also assign one or more text string aliases to a particular entity, which need not be unique among entities. For example, the Statue of Liberty can be associated with aliases “the Statue of Liberty” and “Lady Liberty.”

The system can also store information about an entity's relationship to other entities. For example, the system can define a “located in:” relationship between two entities to reflect, for example, that the Statue of Liberty is located in New York City. In some implementations, the system stores relationships between entities in a representation of a graph in which nodes represent distinct entities and links between nodes represent relationships between the entities. In this example, the system could maintain a node corresponding to the entity the Statue of Liberty, a node corresponding to the entity New York City, and a link between the nodes to represent that the Statue of Liberty is located in New York City.

FIG. 1 illustrates an example web page 100 as display by a web browser. The web page 100 is maintained on a web site of an example merchant “Camera Store” and presents information 120a-f about various camera models for sale. The web page 100 presents camera models for sale sorted in an order, in this example, from lowest price to highest price. The web page 100 is an example of a resource that can include structured data items.

Web site publishers can enhance the information included in a web page by including markup language structured data items, which can then be read and acted upon by a search system. A markup language is a convention for annotating text by syntactically distinguishable elements, e.g., tags. A publisher can include text of a particular markup language in the source document of a web page in order to define structured data items on the web page. The markup language can be XML, HTML, HTML5, or any of a variety of other appropriate markup languages. The markup language data is generally not presented or rendered on a user device, and is rather served on web pages only to be parsed and used by the search systems.

The structured data item specified by the markup language can correspond to a real world person, place, thing, or idea, for example. An example of a markup language schema for defining structured data items can be found at http://schema.org.

The following is an example of a structured data item that is defined by a markup language element, using an example schema from http://schema.org. The example structured data item below corresponds to a camera model and therefore can be included in the web page 100 for enhancing the information included in the page about item 120c which references the camera model. The inclusion of the structured data item on the web page 100 can be detected by a search system, which can determine that the web page includes structured information describing the camera model.

```
<div itemscope itemtype=“http://schema.org/Product”>
    <div itemprop=“name”>CameraFX Q410 Digital Camera</div>
    <div itemprop=“manufacturer”>CameraFX</div>
        <a itemprop=“url”
        href=“http://www.camerastore.com/products/
        CameraFX_Q410.html”>
        </a>
        <div itemprop=“description”>The CameraFX Q410 Digital
Camera is ideal for any photographer, combining both high quality
imaging that makes taking pictures easy.
</div>
        <div>Product ID: <span itemprop=
        “productID”>32720176</div>
    <div>
```

The structured data item itself is distinguished from other content of the web page by “<div>” tags. The “<div>” tags can define an item type, e.g., in this case a “Product,” and can also define various properties of the item. Each property of the item is defined by a name value pair. In this example, the first “itemprop” attribute indicates a property “name” for the camera, and a value of “CameraFX Q410 Digital Camera.” The second “itemprop” attribute indicates a property of “url” for the camera, and a value of “http://www.camerastore.com/products/CameraFX_Q410.html.”

Other web pages on the merchant's web site may provide other ways of organizing the presentation of the same camera models. For example, the web site may provide other web pages that present the same camera models in a different way, e.g., sorted A-Z by name, sorted from highest price to lowest price, and or by popularity, which a user can access, e.g., by selecting links 130.

A search system can map structured data items on web pages of the merchant's web site to entities in order to remove potentially duplicative search results that refer to the same camera models.

FIG. 2 illustrates an example search results page 200. The search results page 200 includes a search button 202, query box 204, into which a user has entered a query 205, “digital camera.” In response to the query, a search system has provided search results 210a-g that are responsive to the query.

Search results 210b-f refer to web pages from a same camera merchant, which all relate to different ways of organizing the presentation of the same camera models. Thus, by parsing structured data items embedded in each web page and mapping the structured data items to entities, a search system can determine that one or more of search results 210a-g are duplicative because they refer to the same entities.

The search system can then remove or decrease the rank of one or more duplicative search results or omit indexing some of the referenced web pages entirely. For example, the search system could remove search results 110d-f or omit indexing search result 110d-f.

FIG. 3 is a diagram of an example system 300. The system 300 includes a user device 310 in communication with a search system 330 over a network 320. The search system 330 is an example of an information retrieval system implemented as one or more computer programs installed on one or more computers in one or more locations, in which the systems, components, and techniques described below can be implemented.

A user can interact with the search system 330 through a user device 310. For example, the user device 310 can be a computer coupled to the search system 330 through a data communication network 320, e.g., a local area network (LAN) or wide area network (WAN), e.g., the Internet, a wireless network, or a combination of networks.

In general, the user device 310 transmits a query 312 over the network 320 to the search system 330. The search system 330 responds to the query 312 by transmitting search results to the user device 310. For example, in some implementations, the search system generates a search results page 316, which the search system 330 transmits over the network 320 to the user device 310 in a form that can be presented on the user device 310, e.g., in the form of a markup language document, e.g., HyperText Markup Language or eXtensible Markup Language document, that can be displayed by a web browser running on the user device 310. The user device 310 can display the search results page 316 by rendering the document on a display device that is part of or coupled to the user device 310.

The user device 310 can be any appropriate type of computing device, e.g., a server, a cloud client device, a mobile phone, a tablet computer, a notebook computer, a music player, an e-book reader, a laptop or desktop computer, a personal digital assistant, a smart phone, or any other appropriate stationary or portable device. The user device will generally include a processor 308 for executing program instructions and a memory, e.g., a random access memory 306, for storing instructions and data. The memory can include both read-only and writable memory. The user device 310 generally runs an application program, e.g., a web browser, that can interact with the search system 330 to display web pages that provide a user interface to the search system 330 for a user of the user device 310.

The search system 330 includes a search engine 340, a structured data parser 350, an entity engine 350, and an entity index database 370. The search engine 340 of the search system 330 will generally include an indexing engine 342 that indexes resources, e.g., resources located on the Internet, and stores the index information in an index database.

When a query is received by the search engine 340, the search engine 340 searches the index database to identify resources that satisfy the query. The search engine 340 will generally also include a ranking engine 344 that generates scores for the resources that satisfy the query. The search engine 340 can rank the resources, e.g., assign a sequential order in which the resources should be presented to a user, according to their respective scores. Like the search engine 330, the ranking engine 344 can be implemented as one or more software modules installed on one or more computers in one or more locations.

The structured data engine 350 identifies structured data items occurring in resources. The structured data engine can then determine whether a particular structured data item corresponds to an entity. In general, the structured data engine 350 parses structured data items to obtain properties of the structured data items and uses entity index database 360 to determine whether the any of the parsed properties are an alias of an entity. In this specification, the term “database” will be used broadly to refer to any collection of data: the data does not need to be structured in any particular way, or structured at all, and it can be stored on storage devices in one or more locations. Thus, for example, the entity index database 340 can include multiple collections of data, each of which may be organized and accessed differently.

The structured data engine 350 can be used in collaboration with indexing engine 342 to associate entities with resources. For example, when indexing engine 342 is indexing a particular resource, structured data engine 350 can parse structured data items embedded in the resource and map the structured data items to corresponding entities. The structured data engine 350 can then provide identifiers of the mapped entities to indexing engine 342. The indexing engine 342 can then associate the resource with the corresponding entity identifiers.

The entity index database 360 generally includes two data structures: one that maps an alias to one or more entities, and another that maps an entity to one or more related entities. The two data structures can be implemented, for example, as indices: (1) an entity alias index that uses text string aliases as keys and (2) an entity relationship index that uses entity identifiers as keys.

For example, in the entity alias index, the alias “Bush” can be mapped to a set of entities having that alias, e.g., the entity “George W. Bush,” the entity “George H. W. Bush,” the entity for the rock band “Bush,” and the entity for a category of plant having that alias. The entity alias index may also include a score for each entity that represents a likelihood that the alias refers to each particular entity.

In the entity relationship index, the entity identifier for the rock band “Bush” can be mapped to related entities “rock music” and members of the band, e.g., the entity “Gavin Rossdale.” The entity relationship index may also include a score for the relationship between entities, which may represent an importance or significance of the relationship. For example, data in the entity relationship index may reflect that an “occupation” relationship between entities “George W. Bush” and “President of the United States” is more significant than a “has birthday in” relationship between entities “George W. Bush” and “July.”

FIG. 4 is a flow chart of an example process 400 for determining that structured data items correspond to entities. The process 400 can be implemented by one or more computer programs installed on one or more computers. The process 400 will be described as being performed by a system of one or more computers, e.g., the structured data engine 350 as described above with reference to FIG. 3.

The system receives data identifying a resource (410). For example, the system may receive data, e.g., a URL, identifying a resource to be indexed by an indexing engine.

The system extracts structured data item properties from structured data items in the resource (420). For example, the system can use a structured data parser to extract structured data items from a resource and identify various properties and their respective values from the structured data items.

The system identifies candidate entities from the structured data item properties (430). The system can for example identify candidate entities by using the value of each extracted property as input to an entity alias index that maps an alias to one or more entities, e.g., the entity index database as described above with reference to FIG. 3.

In some implementations, when identifying candidate entities the system defaults to using values of properties that correspond to a name of the structured data item, for example, the value of the “name” property. The entity alias index can also provide a reference score for each of the candidate entities to which an alias is mapped. The reference score for a candidate entity represents a likelihood that the alias refers to the given candidate entity.

The system disambiguates candidate entities for a structured data item (440). In order to select a candidate entity from multiple candidate entities for a structured data item, the system can adjust scores for the candidate entities based on relationships between the candidate entities and other entities referenced by other properties of the structured data item or in other text of the resource. Computing modified scores to disambiguate candidate entities is described below with reference to FIG. 5.

The system selects a candidate entity and associates the selected entity with the resource (450). Once the system computes modified scores for the candidate entities, the system can select a candidate entity having a highest score. The system can then associate the selected entity with the resource to represent that the resource includes information about the particular entity.

FIG. 5 is a flow chart of an example process 500 for disambiguating two candidate entities for a structured data item. The process 500 can be implemented by one or more computer programs installed on one or more computers. The process 500 will be described as being performed by a system of one or more computers, e.g., the structured data engine 350 as described above with reference to FIG. 3.

The system assigns an initial score to each of the candidate entities (510). For example, the initial score can be the reference score for the candidate entity obtained from an entity alias index that maps an alias to one or more candidate entities and includes a respective reference score for each candidate entity, e.g., the entity alias index as described above with reference to FIG. 3.

The system determines whether any properties of the structured data item or text of the resource refer to related entities (520). For example, the entity for “CameraFX Q410 Camera” may have a manufacturer property with the value “CameraFX.” The system can then determine that “CameraFX” is an alias for the entity of a particular camera manufacturer and that the candidate entity has a “manufactured by” relationship with the entity of the camera manufacturer “CameraFX.” The system can make determinations about entity relationships using an entity relationship index that maps an entity to one or more related entities and includes a link score for each relationship.

The system can also use other text of the resource to disambiguate candidate entities. The system can determine that text of the resource includes occurrences of other entity aliases. For each occurrence of an entity alias in the text of the resource, the system can determine whether any of the corresponding entities are related to the candidate entity.

The system determines a respective modified score for each candidate entity (530). The modified score can be computed based on respective initial scores for related entities and respective link scores between the candidate entity and the related entities. An initial score for a related entity can represent a likelihood that an alias used to identify the related entity refers to the related entity and can be obtained, for example, from the entity alias index that maps aliases to candidate entities. The link score can represent the importance of the relationship between the candidate entity and the related entity and can be obtained, for example, from an entity relationship index.

In some implementations, the system computes a modifier Mᵢ for each related entity REᵢ identified by alias Aᵢ according to:

Mᵢ=IS(Aᵢ,REᵢ)×W(CE,REᵢ),

where IS(Aᵢ,REᵢ) is the initial score for the related entity, and W(CE,REᵢ) is the link score between the candidate entity CE and the related entity REᵢ.

Once each of the modifiers to the initial score for the candidate entity has been computed, the system can compute a modified score using the initial score for the candidate entities and respective modifiers of entities related to the candidate entity. For example, the system can generate the modified score MS for a candidate entity CE having alias A_{c} by adding a sum of the modifiers Mᵢ to the initial score of the candidate entity, IS(A_{c},CE), given by:

MS=IS(A_{c},CE)+ΣᵢMᵢ.

The system selects a candidate entity having a highest modified score (540). After computing modified scores for each candidate entity, the system can disambiguate the candidate entities by selecting a candidate entity having a highest modified score.

FIG. 6 is a flow chart of an example process 600 for indexing resources associated with entities. In general, the system determines that at least two resources are associated with a duplicative entity, and the system determines to index only one of the resources. The process 600 can be implemented by one or more computer programs installed on one or more computers. The process 600 will be described as being performed by a system of one or more computers, e.g., the indexing engine 342 as described above with reference to FIG. 3.

The system receives data identifying resources (610). For example, the system can receive a URL of a first resource and a URL of a second resource. In some implementations, the system only performs process 600 on groups of resources that are located on a same web site. Therefore, the received resources can all be resources that are located on a same web site.

The system determines respective entity sets corresponding to structured data items of each resource (620). The system can parse structured data items included in each resource and map the structured data items to corresponding entities, for example, as described above with reference to FIG. 4. Then, for each resource the system can create an entity set of one or more entity identifiers that correspond to structured data items parsed from the resource.

For example, suppose that web pages of a camera merchant's website are associated with camera model entities, denoted by c1, c2, c3, and c4 to represent four camera models. Structured data items on web page A can be parsed and mapped to entities to generate an entity set with elements {c1, c2, c4}. Likewise, structured data items on web page B can be parsed to generate an entity set with elements {c1, c2}, and structured data items on web page C can be parsed to generate an entity set with elements {c3, c4}.

The system determines that a particular entity set for a resource is duplicative (630). The system can apply a variety of criteria in order to determine that a particular entity set is duplicative.

For example, the system can determine that the particular entity set is a subset of another entity set among the resources. This can include, for example, a particular entity set being identical to another entity set. Continuing the example from above, the system can determine that the entity set of web page B, containing elements {c1, c2}, is a subset of the entity set for web page A. Therefore, the system can determine that the entity set for web page B is duplicative and can, for example, remove page B from, or demote page B on, a search results page.

The system can also treat the entity sets as input to a set cover problem and determine a solution that provides all the entities with the fewest number of entity sets. Continuing the example from above, the system can determine that entity sets for web page B, {c1, c2}, and web page C, {c3, c4} are a solution to the set cover problem because they cover all the entities with a fewest number of sets and with the least overlap among the sets. Thus, the system can determine that the entity set corresponding to entities referenced by web page A is duplicative. The system can use any appropriate set covering algorithm, e.g., a greedy set covering algorithm.

The system indexes the resource with an indication that the entity set is duplicative (640). When indexing the resources, the system can annotate the resources in the index with the entity sets, which can be used by a ranking engine during retrieval. In response to determining that a particular entity set of a resource is duplicative, the system can index the resource with an indication that the entity set is duplicative. During retrieval, a search engine can use the indication that the entity set is duplicative for the resource, and in response determine not to generate a search result for that particular resource.

Alternatively, the system can determine not to index the resource having a duplicative entity set, and instead index only resources having non-duplicative entity sets in a particular index. However, if the system employs multiple tiers of indices, the system may still index resources having duplicate entity sets in one or more lower-tier indices. For example, the system may use a primary index that is accessed more frequently than a secondary index that is more complete. The system can for example limit the primary index to index no more than a threshold number of popular resources, and the system can index less-popular resources in a secondary index that indexes a larger number of resources. In such an arrangement, upon determining that a particular resource among a group of resources is duplicative, the system can index only non-duplicative resources in the primary index, and index all resources of the group of resources in the secondary index.

FIG. 7 is a flow chart of an example process 700 for obtaining search results that reference resources having structured data. In general, the system determines that at least two resources identified by search results are associated with duplicative entities and the system determines modify a rank of one of the search results. The process 600 can be implemented by one or more computer programs installed on one or more computers. The process 600 will be described as being performed by a system of one or more computers, e.g., the ranking engine 344 as described above with reference to FIG. 3.

The system receives search results identifying resources associated with respective entity sets (710). Each entity set for a resource includes entity identifiers that correspond to structured data items of the resource. The entity identifiers can be determined by using property values of the structured data items as entity aliases, for example, as described above with reference to FIG. 4.

The system determines that a particular entity set of the plurality of entity sets is duplicative (720). As described above with reference to FIG. 6, the system can compare the entity sets using a variety of techniques to determine that an entity set is duplicative. The system can, for example, determine that one entity set is a subset of another entity set. The system can also use the entity sets as input to a set coverage algorithm to determine one or more duplicative entity sets. The system can thus designate one or more search results as duplicative search results if they identify resources associated with entity sets determined to be duplicative. In some implementations, the system only considers groups of search results that identify resources on a same web site when determining duplicative search results.

The system modifies a rank of a duplicative search result (730). In general, the system can modify the rank of the search result by applying a demotion to a score of the duplicative search result. In general, the system can apply a demotion to the score of the search result so that a user will generally not see the search result on a search results page.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a plurality of search results obtained in response to a query, wherein the plurality of search results identify respective resources that include markup language structured data items, wherein each resource is associated with an entity set of entity identifiers corresponding to respective structured data items of the resource;
determining that a particular entity set of the plurality of entity sets is duplicative; and
in response to determining that a particular entity set of the plurality of entity sets is duplicative, modifying a ranking score of a particular search result that identifies a resource associated the particular entity set that is duplicative.

2. The method of claim 1, wherein modifying a rank of the particular search result comprises applying a demotion to a score of the particular search result or removing the particular search result from the obtained search results.

3. The method of claim 2, further comprising determining that the particular entity set of the plurality of entity sets is duplicative of one or more entity sets of resources located on a same web site.

4. The method of claim 1, comprising determining each entity identifier including mapping a property value of a corresponding structured data item used as an entity alias to the entity identifier.

5. The method of claim 1, further comprising:
receiving a resource;
determining that the resource includes a particular structured data item that represents a particular entity; and
in an index of resources, annotating the resource with an entity set of one or more entity identifiers that includes an identifier of the particular entity.

6. The method of claim 5, wherein determining that the resource includes a particular structured data item that represents a particular entity comprises:
obtaining a property of the structured data item;
determining that the property corresponds to an alias of a particular entity.

7. The method of claim 6, wherein determining that the resource includes a particular structured data item that represents a particular entity comprises:
obtaining a second property of the structured data item; and
determining that the second property corresponds to an alias of a second particular entity that has a relationship with the particular entity.

8. A system comprising:
one or more computers and one or more storage devices storing instructions that are operable, when executed by the one or more computers, to cause the one or more computers to perform operations comprising:
receiving a plurality of search results obtained in response to a query, wherein the plurality of search results identify respective resources that include markup language structured data items, wherein each resource is associated with an entity set of entity identifiers corresponding to respective structured data items of the resource;
determining that a particular entity set of the plurality of entity sets is duplicative; and
in response to determining that a particular entity set of the plurality of entity sets is duplicative, modifying a ranking score of a particular search result that identifies a resource associated the particular entity set that is duplicative.

9. The system of claim 8, wherein modifying a rank of the particular search result comprises applying a demotion to a score of the particular search result or removing the particular search result from the obtained search results.

10. The system of claim 9, wherein the operations further comprise determining that the particular entity set of the plurality of entity sets is duplicative of one or more entity sets of resources located on a same web site.

11. The system of claim 8, wherein the operations comprise determining each entity identifier including mapping a property value of a corresponding structured data item used as an entity alias to the entity identifier.

12. The system of claim 8, wherein the operations further comprise:
receiving a resource;
determining that the resource includes a particular structured data item that represents a particular entity; and
in an index of resources, annotating the resource with an entity set of one or more entity identifiers that includes an identifier of the particular entity.

13. The system of claim 12, wherein determining that the resource includes a particular structured data item that represents a particular entity comprises:
obtaining a property of the structured data item;
determining that the property corresponds to an alias of a particular entity.

14. The system of claim 13, wherein determining that the resource includes a particular structured data item that represents a particular entity comprises:
obtaining a second property of the structured data item; and
determining that the second property corresponds to an alias of a second particular entity that has a relationship with the particular entity.

15. A computer-implemented method for indexing a plurality of resources comprising:
receiving, by an indexing engine, data identifying each resource of the plurality of resources, wherein each resource includes one or more markup language structured data items;
determining, for the plurality of resources, respective entity sets of one or more entity identifiers, each entity set corresponding to structured data items of a resource, including using a property value of each structured data item as an entity alias;
determining that a particular entity set of the plurality of entity sets is duplicative; and
in response to determining that the particular entity set is duplicative, indexing a particular resource having the duplicative entity set with an indication that the particular entity set is duplicative.

16. The method of claim 15, further comprising:
in the index of resources, annotating the one or more resources with their respective entity sets.

17. The method of claim 15, further comprising determining that the particular entity set of the plurality of entity sets is duplicative of one or more entity sets of resources located on a same web site.

18. The method of claim 15, wherein determining a first entity set of one or more entity identifiers that each correspond to a respective structured data item of the one or more first structured data items comprises:
obtaining a property of a structured data item; and
determining that the property corresponds to an alias of a particular entity.

19. The method of claim 18, wherein determining that the resource includes a particular structured data item that represents a particular entity comprises:
obtaining a second property of the structured data item; and
determining that the second property corresponds to an alias of a second particular entity that has a relationship with the particular entity.

20. A system comprising:
one or more computers and one or more storage devices storing instructions that are operable, when executed by the one or more computers, to cause the one or more computers to perform operations comprising:
receiving, by an indexing engine, data identifying each resource of the plurality of resources, wherein each resource includes one or more markup language structured data items;
determining, for the plurality of resources, respective entity sets of one or more entity identifiers, each entity set corresponding to structured data items of a resource, including using a property value of each structured data item as an entity alias;
determining that a particular entity set of the plurality of entity sets is duplicative; and
in response to determining that the particular entity set is duplicative, indexing a particular resource having the duplicative entity set with an indication that the particular entity set is duplicative.

21. The system of claim 20, wherein the operations further comprise:
in the index of resources, annotating the one or more resources with their respective entity sets.

22. The system of claim 20, wherein the operations further comprise determining that the particular entity set of the plurality of entity sets is duplicative of one or more entity sets of resources located on a same web site.

23. The system of claim 20, wherein determining a first entity set of one or more entity identifiers that each correspond to a respective structured data item of the one or more first structured data items comprises:
obtaining a property of a structured data item; and
determining that the property corresponds to an alias of a particular entity.

24. The system of claim 23, wherein determining that the resource includes a particular structured data item that represents a particular entity comprises:
obtaining a second property of the structured data item; and
determining that the second property corresponds to an alias of a second particular entity that has a relationship with the particular entity.
